(19) United States
(12) Patent Application Publication
(10) Pub. No.: US 2024/0317178 A1
(43) Pub. Date: Sep. 26, 2024

(54) MOVING OBJECT CONTROL DEVICE, MOVING OBJECT CONTROL METHOD, AND RECORDING MEDIUM

(71) Applicant: HONDA MOTOR CO., LTD., Minato-ku, Tokyo (JP)

(72) Inventor: Norio Mizukoshi, Tokyo (JP)

(21) Appl. No.: 18/444,633

(22) Filed: Feb. 17, 2024

(30) Foreign Application Priority Data
Mar. 20, 2023 (JP) 2023-044430

(51) Int. Cl. B60R 25/24; B60R 25/01; G07C 9/00

(52) U.S. Cl. CPC B60R 25/245; B60R 25/01; G07C 9/00309; B60R 2325/101; B60R 2325/205; G07C 2009/00793; G07C 2209/63

(57) ABSTRACT

A moving object control device includes a communication control unit configured to switch a first communication unit between an operating state and a stopped state at a predetermined period; and a target identification information recognizing unit configured to: when a target door operation recognizing unit recognizes an operation on a target door, search for a mobile terminal within a first search range in the vicinity of a target seat outside a moving object in a case where the first communication unit is in an operating state; and start up the first communication unit to search for the mobile terminal within a second search range in the vicinity of the target seat inside and outside the moving object in a case where the first communication unit is in a stopped state.

### INCORPORATION BY REFERENCE

The present application claims priority under 35 U.S.C. § 119 to Japanese Patent Application No. 2023-044430 filed on Mar. 20, 2023. The content of the application is incorporated herein by reference in its entirety.

### BACKGROUND OF THE INVENTION

### Field of the Invention

The present invention relates to a moving object control device, a moving object control method, and a recording medium.

### Description of the Related Art

In recent years, researches and development have been carried out on charging and feeding in moving objects equipped with a secondary battery that contributes to energy efficiency to ensure access to affordable, reliable, sustainable, and advanced energy for more people.

For example, a technique has been proposed in which an authentication process on a smart key is executed using an out-vehicle communicator provided on a target door when operation is performed for opening the target door in a vehicle equipped with a battery, to identify a user who is scheduled to sit in a seat corresponding to the target door (for example, see Japanese Patent Laid-Open No. 2022-84358).

Incidentally, as in the technique disclosed in Japanese Patent Laid-Open No. 2022-84358 as a technique related to charging and feeding in a moving object equipped with a secondary battery, when a user of a moving object is recognized through communication, there is a problem of reducing power from the secondary battery consumed in the moving object.

In order to solve the above problem, the present application invention is to reduce power consumption when the user of the moving object is recognized through communication. Consequently, the present application invention is to contribute to improvement of energy efficiency.

### SUMMARY OF THE INVENTION

To achieve the object described above, a first aspect of the present disclosure provides a moving object control device including: a mobile terminal position recognizing unit configured to, according to a communication situation between a first communication unit provided in a moving object and a mobile terminal used by a user of the moving object, recognize a position of the mobile terminal with respect to the moving object; a target door operation recognizing unit configured to recognize an operation on a target door provided on the moving object, correspondingly to a target seat of the moving object; a target identification information recognizing unit configured to search for the mobile terminal existing near the target seat based on a situation recognized by the mobile terminal position recognizing unit when the target door operation recognizing unit recognizes the operation on the target door, and to recognize terminal identification information transmitted from the mobile terminal as target identification information associated with the user who uses the target seat when the mobile terminal existing near the target seat is detected; and a specific equipment setting unit configured to set specific equipment provided in the moving object, based on a setting condition associated with the target identification information when the target identification information recognizing unit recognizes the target identification information, the moving object control device further including a communication control unit configured to switch the first communication unit between an operating state and a stopped state at a predetermined unit being configured to: when the target door operation recognizing unit recognizes the operation on the target door, search for the mobile terminal within a first search range in the vicinity of the target seat outside the moving object in a case where the first communication unit is in the operating state; and start up the first communication unit to search for the mobile terminal within a second search range in the vicinity of the target seat inside and outside the moving object in a case where the first communication unit is in the stopped state.

In the moving object control device, when searching for the mobile terminal within the second search range, the target identification information recognizing unit may be configured to first search for the mobile terminal within a range outside the moving object in the second search range, and search for the mobile terminal within a range inside the moving object in the second search range when the mobile terminal is not detected within the range outside the moving object in the second search range.

In the moving object control device, the moving object control device may further include a target door open/close recognizing unit configured to recognize an open/close state of the target door, and the target identification information recognizing unit may be configured to search for the mobile terminal within a third search range inside the moving object when the target door operation recognizing unit recognizes that the target door is operated while the target door open/close recognizing unit recognizes that the target door is in an open state.

In the moving object control device, when a plurality of mobile terminals are detected, the target identification information recognizing unit may be configured to estimate, based on changes in positions of the mobile terminals recognized by the mobile terminal position recognizing unit, the mobile terminal used by the user of the target seat, and to recognize the terminal identification information transmitted from the estimated mobile terminal as the target identification information.

In the moving object control device, the specific equipment setting unit may be configured to set the specific equipment, based on setting conditions associated with the target identification information most frequently recognized in the past by the target identification information recognizing unit, in a case where the target identification information recognizing unit does not recognize the target identification information when the target door operation recognizing unit recognizes the operation on the target door.

In the moving object control device, the specific equipment setting unit may be configured to set the specific equipment, based on setting conditions associated with the target identification information previously recognized by the target identification information recognizing unit, in a case where the target identification information recognizing unit does not recognize the target identification information when the target door operation recognizing unit recognizes the operation on the target door.

In the moving object control device, when there is one mobile terminal with the terminal identification information registered in the moving object, the target identification information recognizing unit may be configured to recognize the terminal identification information transmitted from the mobile terminal as the target identification information at a point of time at which communication is established between the mobile terminal and a second communication unit provided in the moving object and communicating with the mobile terminal over a communication range wider than that of the first communication unit.

To achieve the object described above, a second aspect of the present disclosure provides a moving object control method executed by a computer, the method including: a mobile terminal position recognizing step, according to a communication situation between a first communication unit provided in a moving object and a mobile terminal used by a user of the moving object, of recognizing a position of the mobile terminal with respect to the moving object; a target door operation recognizing step of recognizing an operation on a target door provided on the moving object, correspondingly to a target seat of the moving object; a target identification information recognizing step of searching for a mobile terminal existing near the target seat based on a situation recognized in the mobile terminal position recognizing step when the operation on the target door is recognized in the target door operation recognizing step, and recognizing terminal identification information transmitted from the mobile terminal as target identification information associated with the user who uses the target seat when the mobile terminal existing near the target seat is detected; a specific equipment setting step of setting specific equipment provided in the moving object, based on a setting condition associated with the target identification information when the target identification information is recognized in the target identification information recognizing step; and a communication control step of switching the first communication unit between an operating state and a stopped state at a predetermined period, the target identification information recognizing step including: when the operation on the target door is recognized in the target door operation recognizing step, searching for the mobile terminal within a first search range in the vicinity of the target seat outside the moving object in a case where the first communication unit is in the operating state; and starting up the first communication unit to search for the mobile terminal within a second search range in the vicinity of the target seat inside and outside the moving object in a case where the first communication unit is in the stopped state.

To achieve the object described above, a third aspect of the present disclosure provides a non-transitory recording medium storing a program that causes a computer to function as: a mobile terminal position recognizing unit configured to, according to a communication situation between a first communication unit provided in a moving object and a mobile terminal used by a user of the moving object, recognize a position of the mobile terminal with respect to the moving object; a target door operation recognizing unit configured to recognize an operation on a target door provided on the moving object, correspondingly to a target seat of the moving object; a target identification information recognizing unit configured to search for the mobile terminal existing near the target seat based on a situation recognized by the mobile terminal position recognizing unit when the target door operation recognizing unit recognizes the operation on the target door, and to recognize terminal identification information transmitted from the mobile terminal as target identification information associated with the user who uses the target seat when the mobile terminal existing near the target seat is detected; a specific equipment setting unit configured to set specific equipment provided in the moving object, based on a setting condition associated with the target identification information when the target identification information recognizing unit recognizes the target identification information; and a communication control unit configured to switch the first communication unit between an operating state and a stopped state at a predetermined period, the program causing the target identification information recognizing unit to execute a process of: when the target door operation recognizing unit recognizes the operation on the target door, searching for the mobile terminal within a first search range in the vicinity of the target seat outside the moving object in a case where the first communication unit is in the operating state; and starting up the first communication unit to search for the mobile terminal within a second search range in the vicinity of the target seat inside and outside the moving object in a case where the first communication unit is in the stopped state.

According to the moving object control device of the present disclosure, it is possible to reduce power consumption when the user of the moving object is recognized through communication with the mobile terminal used by the user.

### BRIEF DESCRIPTION OF THE DRAWINGS

FIG. 1 is an explanatory diagram of a mode in which a moving object control device recognizes a user who approaches a vehicle and uses a driver's seat;

FIG. 2 is a configuration diagram of the moving object control device;

FIG. 3 is a first flowchart of a process of recognizing an authentication code associated with the user using the driver's seat to set equipment of the vehicle;

FIG. 4 is a second flowchart of a process of recognizing an authentication code associated with the user using the driver's seat to set equipment of the vehicle;

FIG. 5 is an explanatory diagram of a search range of a mobile terminal that is set when the user operates a handle of a driver's seat door;

FIG. 6 is an explanatory diagram of a search range of a mobile terminal that is set when the user operates the handle of the driver's seat door in a state where the driver's seat door is open; and

FIG. 7 is an explanatory diagram of a process when two mobile terminals are detected within an in-vehicle search range.

### DETAILED DESCRIPTION OF THE PREFERRED EMBODIMENTS

### 1. Search for Mobile Terminal Approaching Vehicle

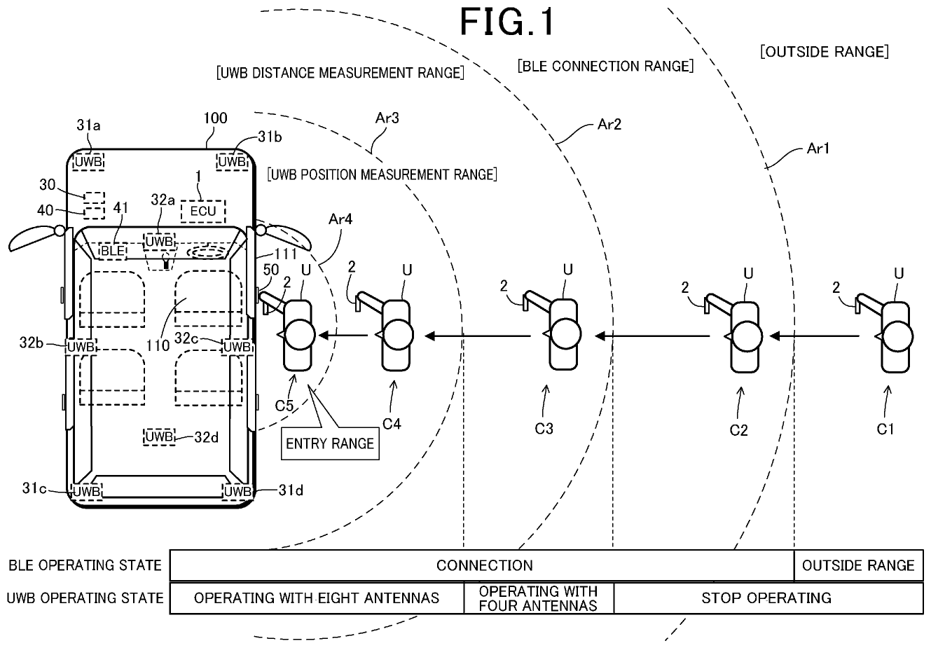

A description will be given with reference to FIG. 1 to an outline of a mode in which a moving object control device 1 according to the present embodiment searches for a mobile terminal 2 owned by a user U approaching a vehicle 100. The moving object control device 1 is mounted on the vehicle 100, and is configured as a function of an electronic control unit (ECU) that controls an operation of the vehicle 100.

An electronic key application (app) is installed in the mobile terminal 2, and the mobile terminal 2 functions as an electronic key including a remote operation function for the vehicle 100 by executing the electronic key app. The mobile terminal 2 is, for example, a wearable device such as a smartphone, a mobile phone, a tablet terminal, or a smart watch, and is used in a state of being carried or worn by the user U.

The vehicle 100 and the mobile terminal 2 communicate with each other using Bluetooth Low Energy (BLE, the Bluetooth being a registered trademark) and Ultra-Wide Band (UWB) communication specifications. In UWB communication, a band from 500 MHz to several dozens of GHz (for example, around an 8 GHz band) is used. The vehicle 100 includes a first communication unit 30 that performs UWB communication, UWB antennas 31a to 31d and 32a to 32d that are connected to the first communication unit 30, a second communication unit 40 that performs BLE communication, and a BLE antenna 41 that is connected to the second communication unit 40.

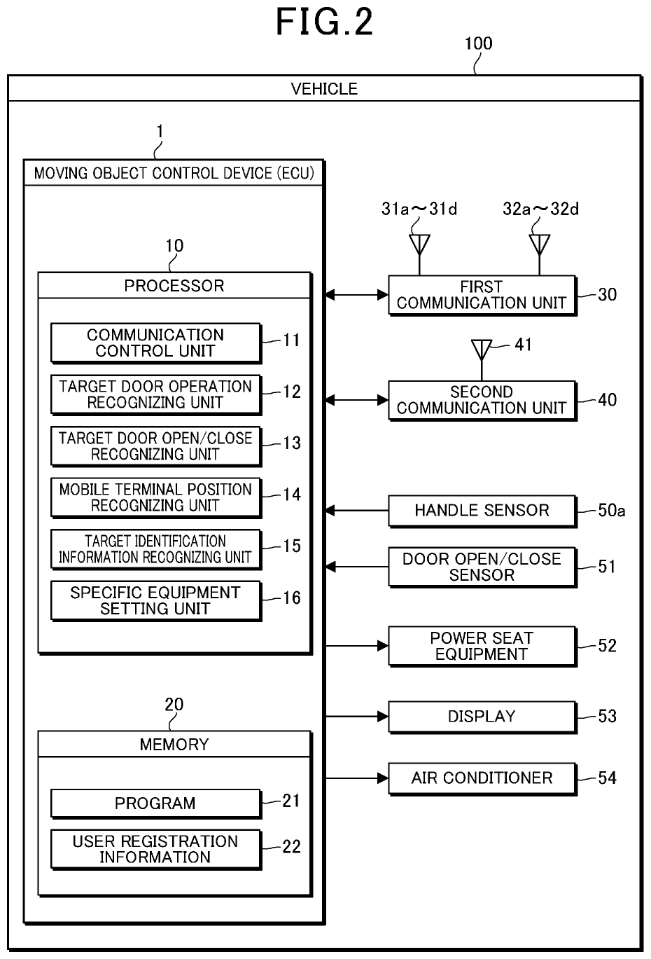

The UWB antennas 31a to 31d are arranged at four corners of the vehicle body of the vehicle 100, and the UWB antennas 32a to 32d are arranged in an interior of the vehicle 100. Further, a handle 50 is provided on a driver's seat door 111, and an operation of the handle 50 by the user U is detected by a handle sensor 50a (see FIG. 2). A driver's seat 110 corresponds to a target seat of the present disclosure, and the driver's seat door 111 corresponds to a target door of the present disclosure.

The moving object control device 1 performs polling using BLE communication via the second communication unit 40, and when the mobile terminal 2 enters from an outside (state of C1) to an inside (state of C2) of a communication area Ar1 for the BLE communication by the second communication unit 40, the BLE communication is established with the mobile terminal 2 within the communication area Ar1. Since a communicable range of the BLE communication is wider than that of the UWB communication and power consumption of the BLE communication is lower than that of the UWB communication, when the polling is performed using the BLE communication in this way, it is possible to recognize the mobile terminal 2 approaching the vehicle 100 while reducing the power consumption.

Then, the moving object control device 1 performs authentication of an electronic key with the mobile terminal 2, and confirms that the mobile terminal 2 is registered as an electronic key of the vehicle 100. Specifically, the moving object control device 1 collates an authentication code (corresponding to terminal identification information of the present disclosure) transmitted from the mobile terminal 2 with an authentication code stored in a memory of the moving object control device 1, thereby confirming that the mobile terminal 2 is registered as an electronic key of the vehicle 100.

Subsequently, when the moving object control device 1 recognizes, based on a rough position of the mobile terminal 2 recognized from radio field intensity of the BLE communication, that the mobile terminal 2 enters an outside (state of C2) to an inside (state of C3) of a communication area Ar2 which is a UWB distance measurement range, the moving object control device 1 allows the first communication unit 30 to start UWB communication using the UWB antennas 31a to 31d as active.

When the moving object control device 1 measures a distance of the mobile terminal 2 from the vehicle 100 using the UWB communication, and recognizes that the mobile terminal 2 enters an outside (state of C3) to an inside (state of C4) of a communication area Ar3 which is a UWB position measurement range, the moving object control device 1 measures the position of the mobile terminal 2 also using the UWB antennas 32a to 32d as active (all of the UWB antennas 31a to 31d and 32a to 32d are in a state of being active). The measurement of distance and position of the mobile terminal 2 with the UWB communication can be performed using a known method disclosed in Japanese Patent Laid-Open No. 2021-096134.

Normally, when the user U approaches the vehicle 100 and operates the handle 50 of the driver's seat door 111, the moving object control device 1 performs, for example, processes of: determining that the user U uses the driver's seat 110; recognizing the authentication code of the mobile terminal 2 as a target authentication code (corresponding to target identification information of the present disclosure); and setting a position of power seat equipment (corresponding to specific equipment of the present disclosure) provided in the driver's seat 110 according to setting conditions stored in the memory corresponding to the target authentication code.

However, there is also a case in which the user U approaches the vehicle 100 and stay near the driver's seat door 111 without getting in the vehicle immediately. In this case, when the UWB communication with the mobile terminal 2 is continued, the power consumption due to the UWB communication will increase, and thus the moving object control device 1 switches the first communication unit 30 between an operating state and a stopped state at a predetermined period to execute a process of reducing the power consumption due to the UWB communication. A description will be made below with respect to control of the vehicle 100 corresponding to the case where the UWB communication is performed intermittently to measure the position of the mobile terminal 2 in this way.

### 2. Configuration of Moving Object Control Device

A configuration of the moving object control device will be described with reference to FIG. 2. The moving object control device 1 is connected with the first communication unit 30, the second communication unit, and the handle sensor 50a which are described above. Further, the moving object control device 1 is connected to a door open/close sensor 51 that detects an open/close state of the driver's seat door 111, power seat equipment 52 (an actuator such as a motor) of the driver's seat 110, a display 53, and an air conditioner 54, for example.

The moving object control device 1 is a control unit including a processor 10 and a memory 20, and the memory 20 stores, for example, a program 21 for controlling the moving object control device 1 and user registration information 22. The program 21 may be read from a recording medium (for example, an optical disc or a flash memory) by the moving object control device 1 and stored in the memory 20, or may be downloaded by the moving object control device 1 from an external server (not shown) or the like and stored in the memory 20.

The user registration information 22 contains the authentication code of the mobile terminal 2 used by the user U of the vehicle 100 and setting conditions (conditions set by the user U) for the specific equipment of the vehicle 100 associated with the authentication code. When the vehicle 100 is shared by a plurality of users U, the authentication code and the setting conditions for the specific equipment are individually saved for each of the users U.

The processor 10 reads and executes the program 21, thereby functioning as a communication control unit 11, a target door operation recognizing unit 12, a target door open/close recognizing unit 13, a mobile terminal position recognizing unit 14, a target identification information recognizing unit 15, and a specific equipment setting unit 16.

A process executed by the communication control unit 11 corresponds to a communication controlling step in a moving object controlling method of the present disclosure, and a process executed by the target door operation recognizing unit 12 corresponds to a target door operation recognizing step in the moving object controlling method of the present disclosure. A process executed by the target door open/close recognizing unit 13 corresponds to a target door open/close recognizing step in the moving object controlling method of the present disclosure, and a process executed by the mobile terminal position recognizing unit 14 corresponds to a mobile terminal position recognizing step in the moving object controlling method of the present disclosure. A process executed by the target identification information recognizing unit 15 corresponds to a target identification information recognizing step of the present disclosure, and a process executed by the specific equipment setting unit 16 corresponds to a specific equipment setting step in the moving object controlling method of the present disclosure.

As described above, the communication control unit 11 executes the process of switching the first communication unit 30 between the operating state and the stopped state at a predetermined period. The target door operation recognizing unit 12 recognizes, based on a detection signal output from the handle sensor 50a, that the handle 50 of the driver's seat door 111 is operated. The target door open/close recognizing unit 13 recognizes, based on a detection signal output from the door open/close sensor 51, whether the driver's seat door 111 is in an open state or a closed state.

As described above, the mobile terminal position recognizing unit 14 recognizes the position of the mobile terminal 2 in relation to the vehicle 100 through the UWB communication between the first communication unit 30 and the mobile terminal 2 or the BLE communication between the second communication unit 40 and the mobile terminal 2. When the handle 50 of the driver's seat door 111 is operated, as will be described later, the target identification information recognizing unit 15 sets a search range of the mobile terminal 2 to search for the mobile terminal 2, and recognizes the authentication code of the mobile terminal 2 detected near the driver's seat 110 as a target authentication code.

The specific equipment setting unit 16 performs setting of the specific equipment provided in the vehicle 100, based on the setting conditions associated with the target authentication code recognized by the target identification information recognizing unit 15. The setting of the specific equipment includes setting of a seat position of the power seat equipment of the driver's seat 110 described above, setting of display contents of the display 53, setting of a temperature of the air conditioner 54, setting of an angle of a door mirror, and setting of angles of rearview mirrors.

### 3. Process of Recognizing Authentication Code and Setting Specific Equipment

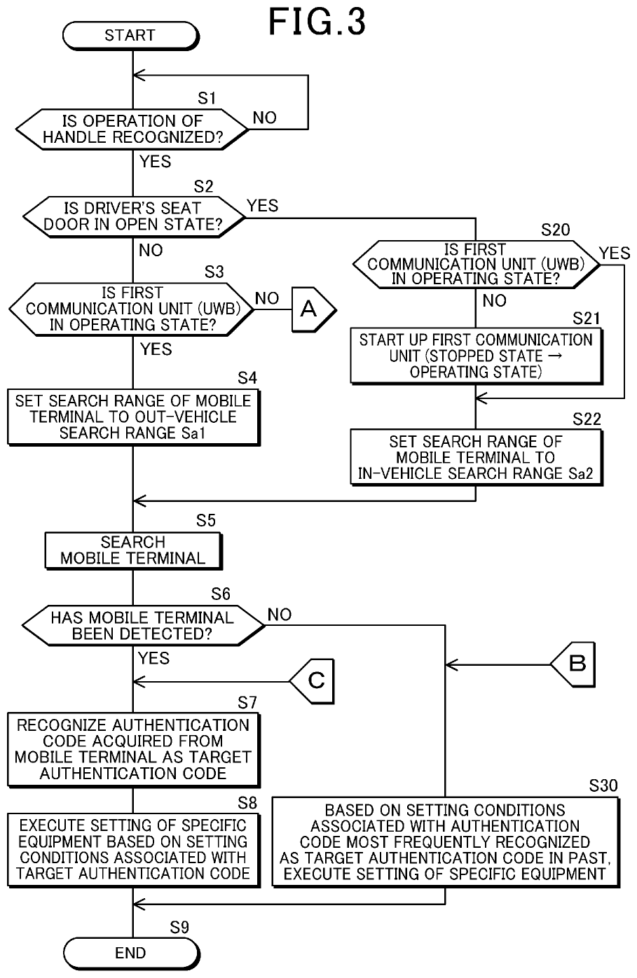

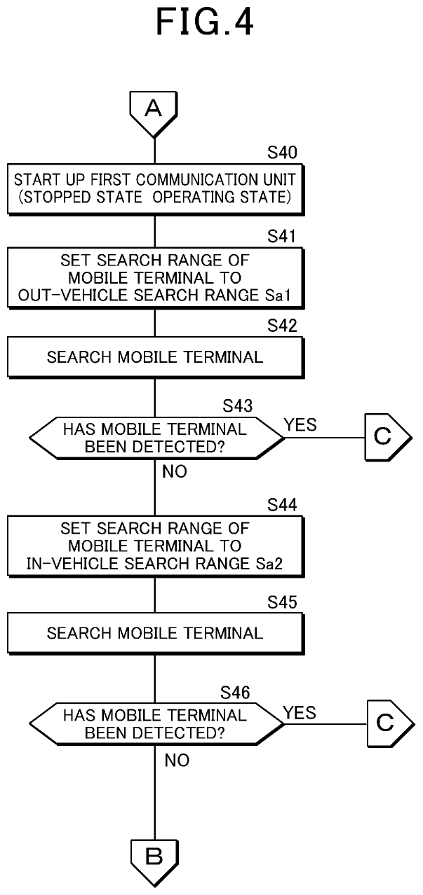

A series of processes will be described according to flowcharts shown in FIGS. 3 and 4 in which the moving object control device recognizes the authentication code of the mobile terminal 2 approaching the driver's seat 110 as a target authentication code and sets the specific equipment of the vehicle 100 with the setting conditions corresponding to the target authentication code. The processes according to the flowcharts shown in FIGS. 3 and 4 are executed in a case where the communication control unit 11 performs a process of switching the first communication unit 30 between an operating state and a stopped state at a predetermined period.

When the target door operation recognizing unit 12 recognizes the operation of the driver's seat door 111 in step S1 of FIG. 3, the target identification information recognizing unit 15 causes the process to proceed to step S2. The target identification information recognizing unit 15 determines in step S2 whether the target door open/close recognizing unit 13 recognizes that the driver's seat door 111 is in an open state. Then, the target identification information recognizing unit 15 causes the process to proceed to step S20 when it is recognized that the driver's seat door 111 is in the open state, and causes the process to proceed to step S3 when it is not recognized that the driver's seat door 111 is in the open state.

The target identification information recognizing unit 15 determines in step S3 whether the first communication unit 30 is in an operating state. Then, the target identification information recognizing unit 15 causes the process to proceed to step S4 when the first communication unit 30 is in the operating state, and causes the process to proceed to step S40 in FIG. 4 when the first communication unit 30 is in a stopped state.

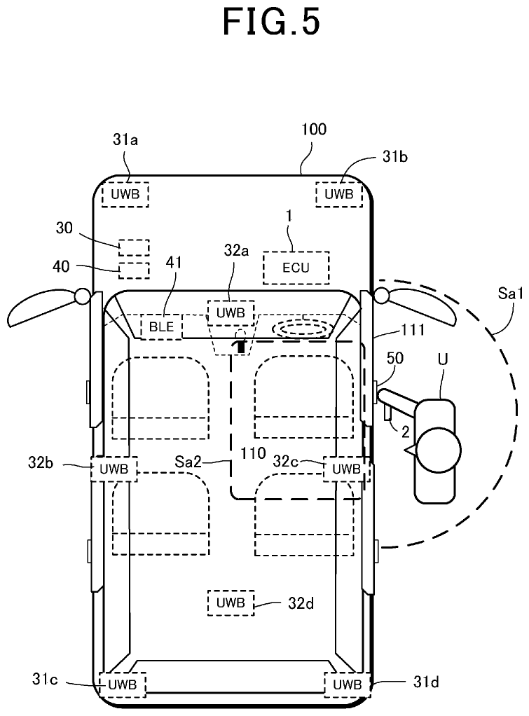

When the first communication unit 30 is in the operating state, the mobile terminal position recognizing unit 14 is expected to be able to quickly detect the mobile terminal 2 by performing UWB communication using the first communication unit 30. Therefore, in step S4, the target identification information recognizing unit 15 sets a search range of the mobile terminal 2 to an out-vehicle search range Sa1 outside the vehicle 100 as shown in FIG. 5. The out-vehicle search range Sa1 in this case corresponds to a first search range of the present disclosure. When the search range of the mobile terminal 2 is limited to the out-vehicle search range Sa1 in this way, it is possible to reduce power consumption during the UWB communication using the first communication unit 30 to search for the mobile terminal 2. In subsequent step S5, the target identification information recognizing unit 15 searches for the mobile terminal 2 based on a situation of the position of the mobile terminal 2 recognized through the UWB communication by the mobile terminal position recognizing unit 14.

The target identification information recognizing unit 15 causes the process to proceed to step S7 when the mobile terminal 2 is detected in subsequent step S6, and causes the process to proceed to step S30 when the mobile terminal 2 is not detected. In step S7, the target identification information recognizing unit 15 recognizes an authentication code acquired from the detected mobile terminal 2 as a target authentication code that is an authentication code associated with the user U who uses the driver's seat 110. The target identification information recognizing unit 15 records the number of times of recognition of the authentication code recognized as the target authentication code in the user registration information 22.

In subsequent step S8, the specific equipment setting unit 16 refers to the user registration information 22 saved in the memory 20, recognizes setting conditions associated with the target authentication code, and sets the specific equipment such as the power seat equipment 52 of the vehicle 100 based on the setting conditions associated with the target authentication code.

Step S30 is a process corresponding to the case where the mobile terminal 2 is not detected, and the specific equipment setting unit 16 refers to the user registration information 22 saved in the memory 20, and extracts the authentication code most frequently recognized as the target authentication code in the past using the target identification information recognizing unit 15. Then, the specific equipment setting unit 16 sets the specific equipment such as the power seat equipment 52 of the vehicle 100 based on setting conditions associated with the extracted authentication code, and causes the process to proceed to step S9.

Steps S20 to S22 are processes corresponding to the case where the handle 50 of the driver's seat door 111 is operated while the driver's seat door 111 is in the open state. The target identification information recognizing unit 15 determines in step S20 whether the first communication unit 30 is in the operating state, and the process proceeds to step S22 when the first communication unit 30 is in the operating state and proceeds to step S21 when the first communication unit 30 is in the stopped state.

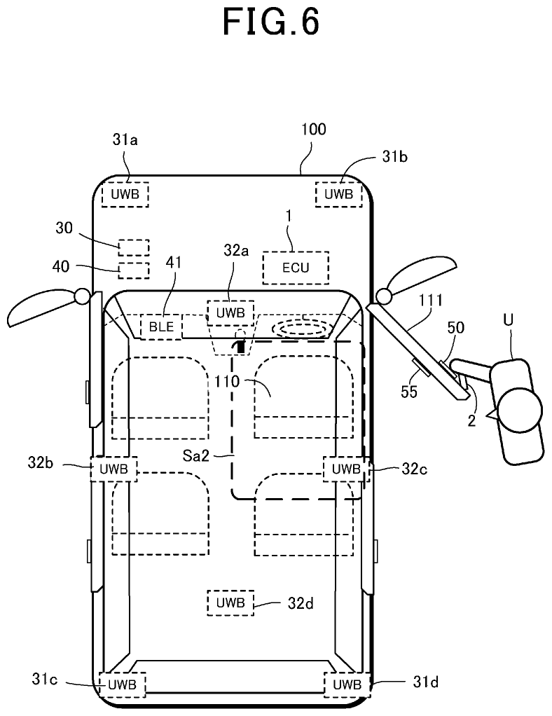

The target identification information recognizing unit 15 starts up the first communication unit 30 in step S21, and causes the process to proceed to step S22. As shown in FIG. 6, when the driver's seat door 111 is in the open state, the user U who operates the handle 50 of the driver's seat door 111 is assumed to quickly get in the vehicle and sit in the driver's seat 110. For this reason, it can be determined that there is a low possibility that the UWB communication between the first communication unit 30 and the mobile terminal 2 is established while the user U is outside the vehicle.

In this case, therefore, the target identification information recognizing unit 15 sets the search range of the mobile terminal 2 to an in-vehicle search range Sa2 inside the vehicle 100 as shown in FIG. 6, and causes the process to proceed to step S5. In this case, the in-vehicle search range Sa2 corresponds to a third search range of the present disclosure. When the search range of the mobile terminal 2 is limited to the in-vehicle search range Sa2 in this way, it is possible for the mobile terminal position recognizing unit 14 to reduce power consumption at the time of searching for the mobile terminal 2 existing within the search range, based on the position of the mobile terminal 2 recognized through the UWB communication by the first communication unit 30.

Although FIG. 6 illustrates a situation in which the handle 50 provided outside of the driver's seat door 111 is operated, the same process can be performed also when a handle 55 provided inside the driver's seat door 111 is operated. Since it is assumed that the inside handle 55 is operated when the user U is sitting in the driver's seat 110 and closing the driver's seat door 111, the search range of the mobile terminal 2 can be set to the in-vehicle search range Sa2, and thus the mobile terminal 2 can be searched efficiently.

Steps S40 to S45 in FIG. 4 are processes corresponding to the case where the driver's seat door 111 is in the closed state and the first communication unit 30 is in the stopped state when the handle 50 of the driver's seat door 111 is operated.

Here, when the first communication unit 30 is in the stopped state, it takes a certain amount of time until the first communication unit 30 is started up and can perform the UWB communication with the mobile terminal 2. For this reason, it is not possible to detect the mobile terminal 2 before the user U gets in the vehicle 100 in some cases.

Therefore, as shown in FIG. 5, the target identification information recognizing unit 15 sets a total range of the out-vehicle search range Sa1 and the in-vehicle search range Sa2 as the search range of the mobile terminal 2 to detect the mobile terminal 2 more reliably. In this case, the total range of the out-vehicle search range Sa1 and the in-vehicle search range Sa2 corresponds to a second search range of the present disclosure. Furthermore, the target identification information recognizing unit 15 first searches for the mobile terminal 2 using the out-vehicle search range Sa1 as a search range, and searches for the mobile terminal 2 using the in-vehicle search range Sa2 as a search range when the mobile terminal 2 is not detected within the out-vehicle search range Sa1. In this way, the search for the mobile terminal 2 is performed step by step, and the search is finished at the point of time when the mobile terminal 2 is detected within the out-vehicle search range Sa1, whereby it is possible to reduce the power consumption due to the UWB communication at the time of searching for the mobile terminal 2.

In FIG. 4, the target identification information recognizing unit 15 starts up the first communication unit 30 in step S40, and sets the search range of the mobile terminal 2 to the out-vehicle search range Sa1 outside the vehicle 100 in step S41. In subsequent step S42, the target identification information recognizing unit 15 searches for the mobile terminal 2 by performing position recognition under the UWB communication using the mobile terminal position recognizing unit 14. The target identification information recognizing unit 15 causes the process to proceed to step S7 of FIG. 3 when the mobile terminal 2 is detected in next step S43, and causes the process to proceed to step S44 when the mobile terminal 2 is not detected in step S43.

In step S44, the target identification information recognizing unit 15 sets the search range of the mobile terminal 2 to the in-vehicle search range Sa2 inside the vehicle 100. In subsequent step S45, the target identification information recognizing unit 15 searches for the mobile terminal 2 by performing position recognition under the UWB communication using the mobile terminal position recognizing unit 14. The target identification information recognizing unit 15 causes the process to proceed to step S7 of FIG. 3 when the mobile terminal 2 is detected in next step S46, and causes the process to proceed to step S30 of FIG. 3 when the mobile terminal 2 is not detected in step S46.

### 4. Other Embodiments

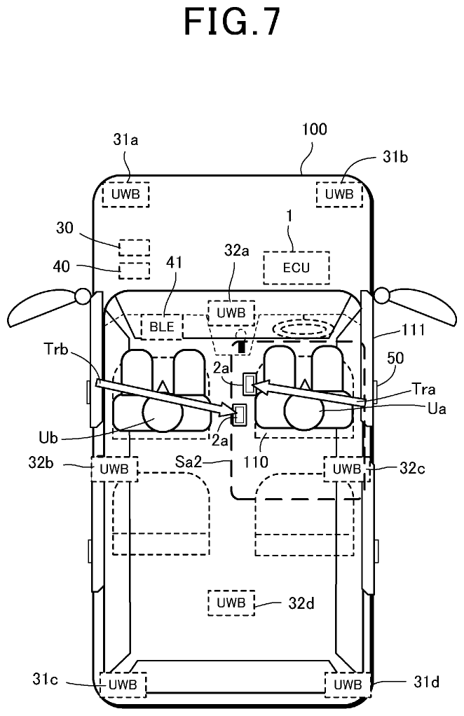

FIG. 7 shows a situation in which the vehicle 100 is shared by a plurality of users Ua and Ub and the users Ua and Ub get into the vehicle 100 when a mobile terminal 2a used by the user Ua and a mobile terminal 2b used by the user Ub are registered in the vehicle 100. In this situation, the target identification information recognizing unit 15 detects the mobile terminals 2a and 2b existing within the in-vehicle search range Sa2, and thus performs a process of determining whether either of the mobile terminals 2a or 2b is a mobile terminal used by the user Ua who uses the driver's seat 110.

In other words, the target identification information recognizing unit 15 determines, based on changes Tra and Trb in positions of the mobile terminals 2a and 2b recognized by the mobile terminal position recognizing unit 14, that the mobile terminal 2a recognized to have been displaced from the driver's seat door 111 toward the driver's seat 110 is the mobile terminal used by the user Ua. Then, the target identification information recognizing unit 15 recognizes an authentication code of the mobile terminal 2a as a target authentication code associated with setting conditions corresponding to the user Ua who uses the driver's seat 110.

Further, when there is only one mobile terminal 2 with an authentication code registered in the vehicle 100, the target identification information recognizing unit 15 may recognize the authentication code transmitted from the mobile terminal 2 as a target authentication code at a point of time at which the BLE communication between the second communication unit 40 and the mobile terminal 2 is established (state of C2 in FIG. 1). Thereby, the specific equipment setting unit 16 can quickly set the specific equipment.

The vehicle 100 is exemplified as the moving object of the present disclosure in the above-described embodiment, but the moving object of the present disclosure may be any moving object, such as a flying object or a boat, which detects the mobile terminal used by the user who uses the target seat based on the position of the mobile terminal recognized through the communication and sets the specific equipment according to the terminal identification information of the mobile terminal.

In the above-described embodiment, as shown in FIG. 6, the target identification information recognizing unit 15 performs a process of setting the search range of the mobile terminal 2 to the in-vehicle search range Sa2 when the driver's seat door 111 is in the open state, but a configuration may be adopted in which the process is omitted.

In the above-described embodiment, the configuration is exemplified that includes the first communication unit 30 configured to recognize the position of the mobile terminal 2 with respect to the vehicle 100 through the UWB communication and the second communication unit 40 configured to recognize the position of the mobile terminal 2 with respect to the vehicle 100 through the BLE communication, but a configuration may be provided to recognize the position of the mobile terminal 2 with respect to the vehicle 100 using other communication specifications.

In the above-described embodiment, examples are shown in which the driver's seat 110 corresponds to the target seat of the present disclosure and the driver's seat door 111 corresponds to the target door of the present disclosure, but the same process may be applied to a passenger seat or rear seats. In other words, the authentication code of the mobile terminal used by the user using each seat is recognized as the target authentication code, and thus the setting of the specific equipment such as the setting of the seat position of each seat can be performed according to the setting conditions associated with the target authentication code.

In the above-described embodiment, as shown in steps S6 and S30 of FIG. 3, when the mobile terminal 2 is not detected when the operation of the driver's seat door 111 is recognized by the target door operation recognizing unit 12, the specific equipment setting unit 16 sets the specific equipment such as the power seat equipment 52 of the vehicle 100 based on the setting conditions associated with the authentication code most frequently recognized as the target authentication code in the past. As other embodiments, when the mobile terminal 2 is not detected when the operation of the driver's seat door 111 is recognized by the target door operation recognizing unit 12, the specific equipment setting unit 16 may set the specific equipment of the vehicle 100 based on setting conditions associated with the authentication code recognized as the target authentication code at a previous time.

FIGS. 1 and 2 are schematic diagrams showing the configuration of the moving object control device 1 divided by main process contents in order to facilitate understanding of the invention of the present disclosure, and the moving object control device 1 may be configured by other divisions. Furthermore, the process of each component may be executed by one hardware unit, or by a plurality of hardware units. Further, the process by each component shown in FIGS. 3 and 4 may be executed by one program, or by a plurality of programs.

### 5. Configurations Supported by Embodiment Described Above

The above-described embodiment supports the following configurations.
(Configuration 1) A moving object control device including: a mobile terminal position recognizing unit configured to, according to a communication situation between a first communication unit provided in a moving object and a mobile terminal used by a user of the moving object, recognize a position of the mobile terminal with respect to the moving object; a target door operation recognizing unit configured to recognize an operation on a target door provided on the moving object, correspondingly to a target seat of the moving object; a target identification information recognizing unit configured to search for a mobile terminal existing near the target seat based on a situation recognized by the mobile terminal position recognizing unit when the target door operation recognizing unit recognizes the operation on the target door, and to recognize terminal identification information transmitted from the mobile terminal as target identification information associated with the user who uses the target seat when the mobile terminal existing near the target seat is detected; and a specific equipment setting unit configured to set specific equipment provided in the moving object, based on a setting condition associated with the target identification information when the target identification information recognizing unit recognizes the target identification information, the moving object control device further including a communication control unit configured to switch the first communication unit between an operating state and a stopped state at a predetermined unit being configured to: when the target door operation recognizing unit recognizes the operation on the target door, search for the mobile terminal within a first search range in the vicinity of the target seat outside the moving object in a case where the first communication unit is in the operating state; and start up the first communication unit to search for the mobile terminal within a second search range in the vicinity of the target seat inside and outside the moving object in a case where the first communication unit is in the stopped state.

According to the moving object control device of Configuration 1, when the first communication unit is switched between the operating state and the stopped state at the predetermined period by the communication control unit, the first communication unit is reduced in standby power at the time of communication with the mobile terminal approaching the moving object. Then, when the operation on the target door is recognized, the communication between the first communication unit and the mobile terminal is quickly established when the first communication unit is in the operating state, and it is expected that the mobile terminal position recognizing unit recognizes the position of the mobile terminal when the user is outside the moving object near the target door, whereby it is possible to reduce the power consumption of the first communication unit by searching for the mobile terminal within the first searching range outside the moving object. Further, when the first communication unit is in the stopped state when the operation on the target door is recognized, since the mobile terminal position recognizing unit requires a certain amount of time to start up the first communication unit, it is also assumed that the user will get in the moving object until the communication between the first communication unit and the mobile terminal is established. Therefore, by searching for the mobile terminal within the second search range inside and outside the moving object, communication between the first communication unit and the mobile terminal brought inside the moving object can also be established to recognize the target identification information.
(Configuration 2) In the moving object control device according to Configuration 1, when searching for the mobile terminal within the second search range, the target identification information recognizing unit first searches for the mobile terminal within a range outside the moving object in the second search range, and searches for the mobile terminal within a range inside the moving object in the second search range when the mobile terminal is not detected within the range outside the moving object in the second search range.

According to the moving object control device of Configuration 2, the communication range of the first communication unit is expanded to the inside of the moving object only when the communication between the first communication unit and the mobile terminal is not established in the range outside the moving object, and thus it is possible to reduce the power consumption of the first communication unit compared to the case where the communication range of the first communication unit is set to the outside and the inside of the moving object from the beginning.
(Configuration 3) In the moving object control device according to Configuration 1 or 2, the moving object control device further including: a target door open/close recognizing unit configured to recognize an open/close state of the target door, and the target identification information recognizing unit searches for the mobile terminal within a third search range inside the moving object when the target door operation recognizing unit recognizes that the target door is operated while the target door open/close recognizing unit recognizes that the target door is in an open state.

According to the moving object control device of Configuration 3, when the target door is operated while the target door is already open, it is assumed that the user quickly gets in the moving object. Therefore, in this case, the mobile terminal is searched within the third search range inside the moving object, whereby the power consumption of the first communication unit can be reduced and the communication between the first communication unit and the mobile terminal can be established more efficiently.
(Configuration 4) In the moving object control device according to any one of Configurations 1 to 3, when a plurality of mobile terminals are detected, the target identification information recognizing unit estimates, based on changes in positions of the mobile terminals recognized by the mobile terminal position recognizing unit, the mobile terminal used by the user of the target seat, and recognizes the terminal identification information transmitted from the estimated mobile terminal as the target identification information.

According to the moving object control device of Configuration 4, based on the change in the position of the mobile terminal, it is possible to recognize the terminal identification information of the mobile terminal, which is recognized to have moved near the target seat, as target identification information.
(Configuration 5) In the moving object control device according to any one of Configurations 1 to 4, the specific equipment setting unit sets the specific equipment, based on setting conditions associated with the target identification information most frequently recognized in the past by the target identification information recognizing unit, in a case where the target identification information recognizing unit does not recognize the target identification information when the target door operation recognizing unit recognizes the operation on the target door.

According to the moving object control device of Configuration 5, when the user gets in the moving object without carrying the mobile terminal, it is possible to set the specific equipment based on the setting conditions associated with the user who is estimated to be most likely to use the moving object from the number of times the user has used the moving object in the past.
(Configuration 6) In the moving object control device according to any one of Configurations 1 to 5, the specific equipment setting unit sets the specific equipment, based on setting conditions associated with the target identification information previously recognized by the target identification information recognizing unit, in a case where the target identification information recognizing unit does not recognize the target identification information when the target door operation recognizing unit recognizes the operation on the target door.

According to the moving object control device of Configuration 6, when the user gets in the moving object without carrying the mobile terminal, it is possible to set the specific equipment based on the setting conditions associated with the user who uses the moving object at the previous time.
(Configuration 7) In the moving object control device according to any one of Configurations 1 to 6, when there is one mobile terminal with the terminal identification information registered in the moving object, the target identification information recognizing unit recognizes the terminal identification information transmitted from the mobile terminal as the target identification information at a point of time at which communication is established between the mobile terminal and a second communication unit provided in the moving object and communicating with the mobile terminal over a communication range wider than that of the first communication unit.

According to the moving object control device of Configuration 7, when there is one mobile terminal with terminal identification information registered in the moving object, the terminal identification information is acquired at a point of time at which the communication between the second communication unit and the mobile terminal is established, and thus there is no need for a process of acquiring the terminal identification information through the communication between the first communication unit and the mobile terminal, whereby it is possible to quickly set the specific equipment while reducing the power consumption of the first communication unit.
(Configuration 8) A moving object control method executed by a computer, the method including: a mobile terminal position recognizing step, according to a communication situation between a first communication unit provided in a moving object and a mobile terminal used by a user of the moving object, of recognizing a position of the mobile terminal with respect to the moving object; a target door operation recognizing step of recognizing an operation on a target door provided on the moving object, correspondingly to a target seat of the moving object; a target identification information recognizing step of searching for a mobile terminal existing near the target seat based on a situation recognized in the mobile terminal position recognizing step when the operation on the target door is recognized in the target door operation recognizing step, and recognizing terminal identification information transmitted from the mobile terminal as target identification information associated with the user who uses the target seat when the mobile terminal existing near the target seat is detected; a specific equipment setting step of setting specific equipment provided in the moving object, based on a setting condition associated with the target identification information when the target identification information is recognized in the target identification information recognizing step; and a communication control step of switching the first communication unit between an operating state and a stopped state at a predetermined period, the target identification information recognizing step including: when the operation on the target door is recognized in the target door operation recognizing step, searching for the mobile terminal within a first search range in the vicinity of the target seat outside the moving object in a case where the first communication unit is in the operating state; and starting up the first communication unit to search for the mobile terminal within a second search range in the vicinity of the target seat inside and outside the moving object in a case where the first communication unit is in the stopped state.

According to the moving object control method executed by a computer of Configuration 8, the same effect as in the moving object control device of Configuration 1 can be obtained.
(Configuration 9) A non-transitory recording medium storing a program that causes a computer to function as: a mobile terminal position recognizing unit configured to, according to a communication situation between a first communication unit provided in a moving object and a mobile terminal used by a user of the moving object, recognize a position of the mobile terminal with respect to the moving object; a target door operation recognizing unit configured to recognize an operation on a target door provided on the moving object, correspondingly to a target seat of the moving object; a target identification information recognizing unit configured to search for the mobile terminal existing near the target seat based on a situation recognized by the mobile terminal position recognizing unit when the target door operation recognizing unit recognizes the operation on the target door, and to recognize terminal identification information transmitted from the mobile terminal as target identification information associated with the user who uses the target seat when the mobile terminal existing near the target seat is detected; a specific equipment setting unit configured to set specific equipment provided in the moving object, based on a setting condition associated with the target identification information when the target identification information recognizing unit recognizes the target identification information; and a communication control unit configured to switch the first communication unit between an operating state and a stopped state at a predetermined period, the program causing the target identification information recognizing unit to execute a process of: when the target door operation recognizing unit recognizes the operation on the target door, searching for the mobile terminal within a first search range in the vicinity of the target seat outside the moving object in a case where the first communication unit is in the operating state; and starting up the first communication unit to search for the mobile terminal within a second search range in the vicinity of the target seat inside and outside the moving object in a case where the first communication unit is in the stopped state.

According to the program executable by the computer of Configuration 9, it is possible to realize the configuration of the moving object control device of Configuration 1.

### REFERENCE SIGNS LIST

1 moving object control device
2 mobile terminal
10 processor
11 communication control unit
12 target door operation recognizing unit
13 target door open/close recognizing unit
14 mobile terminal position recognizing unit
15 target identification information recognizing unit
16 specific equipment setting unit
20 memory
21 program
22 user registration information
30 first communication unit
31a to 31f, 32a to 32d UWB antenna
40 second communication unit
41 BLE antenna
50 handle
50a handle sensor
51 door open/close sensor
52 power seat equipment
53 display
54 air conditioner
100 vehicle (moving object)
110 driver's seat (target seat)
111 driver's seat door (target door)
U user

What is claimed is:

1. A moving object control device comprising:
a mobile terminal position recognizing unit configured to, according to a communication situation between a first communication unit provided in a moving object and a mobile terminal used by a user of the moving object, recognize a position of the mobile terminal with respect to the moving object;
a target door operation recognizing unit configured to recognize an operation on a target door provided on the moving object, correspondingly to a target seat of the moving object;
a target identification information recognizing unit configured to search for the mobile terminal existing near the target seat based on a situation recognized by the mobile terminal position recognizing unit when the target door operation recognizing unit recognizes the operation on the target door, and to recognize terminal identification information transmitted from the mobile terminal as target identification information associated with the user who uses the target seat when the mobile terminal existing near the target seat is detected; and
a specific equipment setting unit configured to set specific equipment provided in the moving object, based on a setting condition associated with the target identification information when the target identification information recognizing unit recognizes the target identification information,
the moving object control device further comprising a communication control unit configured to switch the first communication unit between an operating state and a stopped state at a predetermined period,
the target identification information recognizing unit being configured to: when the target door operation recognizing unit recognizes the operation on the target door, search for the mobile terminal within a first search range in the vicinity of the target seat outside the moving object in a case where the first communication unit is in the operating state; and start up the first communication unit to search for the mobile terminal within a second search range in the vicinity of the target seat inside and outside the moving object in a case where the first communication unit is in the stopped state.

2. The moving object control device according to claim 1, wherein
when searching for the mobile terminal within the second search range, the target identification information recognizing unit first searches for the mobile terminal within a range outside the moving object in the second search range, and searches for the mobile terminal within a range inside the moving object in the second search range when the mobile terminal is not detected within the range outside the moving object in the second search range.

3. The moving object control device according to claim 1, further comprising:
a target door open/close recognizing unit configured to recognize an open/close state of the target door, wherein
the target identification information recognizing unit searches for the mobile terminal within a third search range inside the moving object when the target door operation recognizing unit recognizes that the target door is operated while the target door open/close recognizing unit recognizes that the target door is in an open state.

4. The moving object control device according to claim 1, wherein
when a plurality of the mobile terminals are detected, the target identification information recognizing unit estimates, based on changes in positions of the mobile terminals recognized by the mobile terminal position recognizing unit, the mobile terminal used by the user of the target seat, and recognizes the terminal identification information transmitted from the estimated mobile terminal as the target identification information.

5. The moving object control device according to claim 1, wherein
the specific equipment setting unit sets the specific equipment, based on setting conditions associated with the target identification information most frequently recognized in the past by the target identification information recognizing unit, in a case where the target identification information recognizing unit does not recognize the target identification information when the target door operation recognizing unit recognizes the operation on the target door.

6. The moving object control device according to claim 1, wherein
the specific equipment setting unit sets the specific equipment, based on setting conditions associated with the target identification information previously recognized by the target identification information recognizing unit, in a case where the target identification information recognizing unit does not recognize the target identification information when the target door operation recognizing unit recognizes the operation on the target door.

7. The moving object control device according to claim 1, wherein
when there is one mobile terminal with the terminal identification information registered in the moving object, the target identification information recognizing unit recognizes the terminal identification information transmitted from the mobile terminal as the target identification information at a point of time at which communication is established between the mobile terminal and a second communication unit provided in the moving object and communicating with the mobile terminal over a communication range wider than that of the first communication unit.

8. A moving object control method executed by a computer, the method comprising:
a mobile terminal position recognizing step, according to a communication situation between a first communication unit provided in a moving object and a mobile terminal used by a user of the moving object, of recognizing a position of the mobile terminal with respect to the moving object;
a target door operation recognizing step of recognizing an operation on a target door provided on the moving object, correspondingly to a target seat of the moving object;
a target identification information recognizing step of searching for the mobile terminal existing near the target seat based on a situation recognized in the mobile terminal position recognizing step when the operation on the target door is recognized in the target door operation recognizing step, and recognizing terminal identification information transmitted from the mobile terminal as target identification information associated with the user who uses the target seat when the mobile terminal existing near the target seat is detected;
a specific equipment setting step of setting specific equipment provided in the moving object, based on a setting condition associated with the target identification information when the target identification information is recognized in the target identification information recognizing step; and
a communication control step of switching the first communication unit between an operating state and a stopped state at a predetermined period,
the target identification information recognizing step including: when the operation on the target door is recognized in the target door operation recognizing step, searching for the mobile terminal within a first search range in the vicinity of the target seat outside the moving object in a case where the first communication unit is in the operating state; and starting up the first communication unit to search for the mobile terminal within a second search range in the vicinity of the target seat inside and outside the moving object in a case where the first communication unit is in the stopped state.

9. A non-transitory recording medium storing a program that causes a computer to function as:
a mobile terminal position recognizing unit configured to, according to a communication situation between a first communication unit provided in a moving object and a mobile terminal used by a user of the moving object, recognize a position of the mobile terminal with respect to the moving object;
a target door operation recognizing unit configured to recognize an operation on a target door provided on the moving object, correspondingly to a target seat of the moving object;
a target identification information recognizing unit configured to search for the mobile terminal existing near the target seat based on a situation recognized by the mobile terminal position recognizing unit when the target door operation recognizing unit recognizes the operation on the target door, and to recognize terminal identification information transmitted from the mobile terminal as target identification information associated with the user who uses the target seat when the mobile terminal existing near the target seat is detected;
a specific equipment setting unit configured to set specific equipment provided in the moving object, based on a setting condition associated with the target identification information when the target identification information recognizing unit recognizes the target identification information; and
a communication control unit configured to switch the first communication unit between an operating state and a stopped state at a predetermined period,
the program causing the target identification information recognizing unit to execute a process of: when the target door operation recognizing unit recognizes the operation on the target door, searching for the mobile terminal within a first search range in the vicinity of the target seat outside the moving object in a case where the first communication unit is in the operating state; and starting up the first communication unit to search for the mobile terminal within a second search range in the vicinity of the target seat inside and outside the moving object in a case where the first communication unit is in the stopped state.
